(19) United States
(12) Patent Application Publication
(10) Pub. No.: US 2026/0185869 A1
(43) Pub. Date: Jul. 2, 2026

(54) LISTENING SOUND OBTAINING METHOD AND LISTENING SOUND OBTAINING APPARATUS

(71) Applicant: YAMAHA CORPORATION, Hamamatsu-shi (JP)

(72) Inventors: Kohei ANDO, Kawasaki-shi (JP); Kohei Kanamori, Hamamatsu-shi (JP); Takashi Yamakawa, Iwata-shi (JP); Hirotaka Aiba, Hamamatsu-shi (JP); Masashi Suzuki, Hamamatsu-shi (JP)

(21) Appl. No.: 19/546,531

(22) Filed: Feb. 23, 2026

Related U.S. Application Data
(63) Continuation of application No. PCT/JP2024/030652, filed on Aug. 28, 2024.

(30) Foreign Application Priority Data
Aug. 28, 2023 (JP) 2023-137780
Feb. 14, 2024 (JP) 2024-019952
Jun. 14, 2024 (JP) 2024-096494

(51) Int. Cl. G01H 3/12; H04R 29/00

(52) U.S. Cl. CPC G01H 3/12; H04R 29/001

(57) ABSTRACT

A listening sound obtaining method for a voice amplification system, including a sound collector, an amplifier, and a sound emitter, that sends a speech sound of a speaker to a listener through at least a voice amplification transfer route that includes the sound collector, the amplifier, and the sound emitter, the listening sound obtaining method obtains a first sound pressure at any position on the voice amplification transfer route of the speech sound, and calculates a second sound pressure at a listening position of the listener based on the obtained first sound pressure.

### CROSS REFERENCE TO RELATED APPLICATIONS

The present application is a continuation application of International Patent Application No. PCT/JP2024/030652, filed on Aug. 28, 2024, which claims priority to Japanese Patent Application No. 2023-137780, filed on Aug. 28, 2023, Japanese Patent Application No. 2024-019952, filed on Feb. 14, 2024 and Japanese Patent Application No. 2024-096494, filed on Jun. 14, 2024. The contents of these applications are incorporated herein by reference in their entirety.

### BACKGROUND

### Technical Field

One embodiment of the present invention relates to a listening sound obtaining method and a listening sound obtaining apparatus.

### Background Information

In a conference system, a sound emitter to amplify a speech sound and transmit to a conference participant is provided in a conference room so that all conference participants can clearly listen to the speech sound. In this kind of the conference system, it is necessary to amplify the speech sound so that the speech sound of a speaker reaches may reach a listener at a sufficient sound pressure. Japanese Unexamined Patent Application Publication No. 2001-245365 discloses a technique that, although concerning a remote control, notifies an execution state of amplification in an area in which an speech sound is amplified.

### SUMMARY

However, the technique of Japanese Unexamined Patent Application Publication No. 2001-245365 only notifies an execution state of amplification, and even when this notification is received, it is difficult to determine whether or not a speech sound reaches a listener at the sufficient sound pressure.

One embodiment of the present invention is made in view of the above circumstances and is directed to provide a listening sound obtaining method that obtains a sound pressure of an speech sound.

### Solution to Problem

In a listening sound obtaining method for a voice amplification system, including a sound collector, an amplifier, and a sound emitter, that sends a speech sound of a speaker to a listener through at least a voice amplification transfer route that includes the sound collector, the amplifier, and the sound emitter, the listening sound obtaining method obtains a first sound pressure at any position on the voice amplification transfer route of the speech sound, and calculates a second sound pressure at a listening position of the listener based on the obtained first sound pressure.

### BRIEF DESCRIPTION OF THE DRAWINGS

FIG. 1 is a block diagram showing a configuration of a listening sound obtaining apparatus and a conference system that execute a listening sound obtaining method being one embodiment of the present invention.

FIG. 2 is a block diagram showing a hardware configuration of the listening sound obtaining apparatus 200.

FIG. 3 is a view showing a configuration example of a transfer system of a speech sound in the same embodiment.

FIG. 4 is a block diagram of the same transfer system.

FIG. 5 is a block diagram showing a listening sound obtaining method in the same transfer system.

FIG. 6 is a block diagram showing a generalized transfer system of the speech sound in the same embodiment.

FIG. 7 is a block diagram showing a transfer route that configures the same transfer system.

FIG. 8 is a block diagram showing the listening sound obtaining method in the same transfer system.

FIG. 9 is a view showing an example of an information providing portion in the same embodiment.

FIG. 10 is a flowchart of listening sound obtaining processing to be executed in the same embodiment.

FIG. 11 is a block diagram showing a listening sound obtaining method being another embodiment of the present invention.

FIG. 12 is a diagram showing a modification of visible information.

FIG. 13 is a diagram showing a modification of visible information.

FIG. 14 is a side surface schematic diagram of a conference room.

FIG. 15 is a diagram showing a further modification of visible information.

FIG. 16 is a diagram showing a further modification of visible information.

FIG. 17 is a diagram showing a further modification of visible information.

### DETAILED DESCRIPTION

Hereinafter, an embodiment of the present invention will be described with reference to drawings.

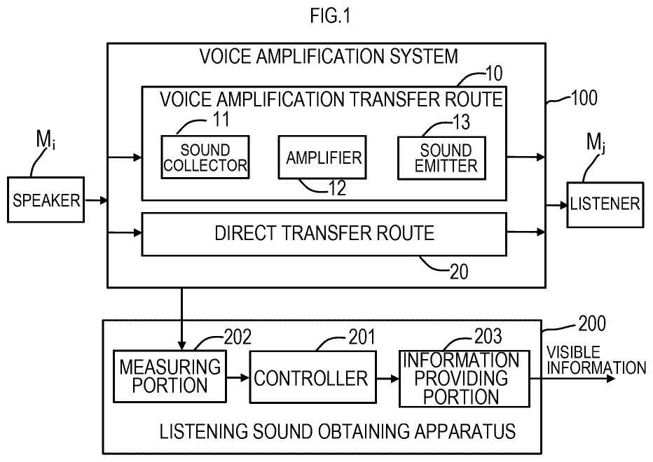

FIG. 1 is a block diagram showing a configuration of a listening sound obtaining apparatus 200 and a voice amplification system 100 that execute a listening sound obtaining method being one embodiment of the present invention. Obtaining a listening sound in the present embodiment sound emitters obtaining information on a sound pressure (spm) of a listening sound.

The listening sound obtaining method according to the present embodiment is targeted at the voice amplification system 100 shown in FIG. 1. The voice amplification system 100 of the present embodiment, that is, the voice amplification system 100 being a system in which a voice of a certain speaker is amplified and sent to a listener is used for, for example, a conference, a seminar, a presentation, or the like. The present embodiment shows an example that uses the voice amplification system 100 for a conference as an example. In the voice amplification system 100, an speech sound of a conference participant Mi being an speaker reaches a conference participant Mj being a listener through a voice amplification transfer route 10 including a sound collector 11, an amplifier 12, and a sound emitter 13, and the speech sound reaches the conference participant Mj through a direct transfer route 20 that does not include the voice amplification transfer route 10.

The listening sound obtaining apparatus 200 is an apparatus that obtains a sound pressure of a conference participant Mj being a listener at a listening position by arithmetic operation, in such a voice amplification system 100. The listening sound obtaining apparatus 200, although being shown as an external device of the voice amplification system 100 in FIG. 1, may be an apparatus included in a control apparatus (not shown) of the voice amplification system 100.

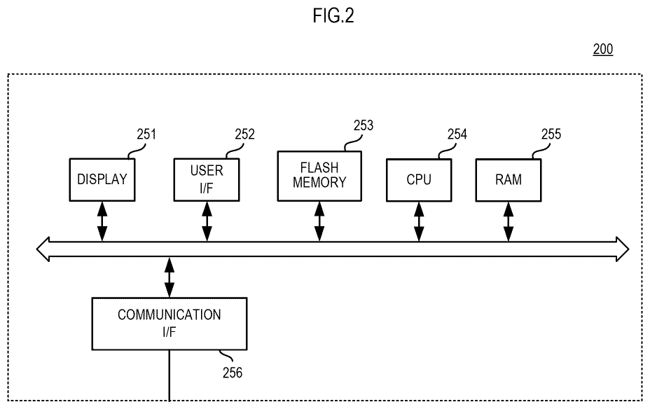

FIG. 2 is a block diagram showing a hardware configuration of the listening sound obtaining apparatus 200. The listening sound obtaining apparatus 200 is made of a general-purpose information processing apparatuses such as a personal computer or a smartphone, as an example. The general-purpose information processing apparatus may be an apparatus that a speaker uses or may be an apparatus that an operator who operates a conference, an installer who installs a conference system, or a similar party uses.

The listening sound obtaining apparatus 200 includes a display 251, a user I/F 252, a flash memory 253, a CPU 254, a RAM 255, and a communication I/F 256.

The display 251 includes an LCD, an OLED, or the like, for example, and displays various information. The user I/F 252 is, for example, a touch panel stacked on the LCD or the OLED being the display 251. Alternatively, the user I/F 252 may be a keyboard, a mouse, or the like. In a case in which the user I/F 252 is a touch panel, the user I/F 252 constitutes a GUI (Graphical User Interface) together with the display 251.

The communication I/F 256 is a communication sound emitter such as a wireless LAN, Bluetooth (registered trademark), or the like. The communication I/F 256 receives an audio signal, for example from the voice amplification system 100.

The CPU 254 is an example of a processor and is a controller that controls an operation of the listening sound obtaining apparatus 200. The CPU 254 reads and executes a predetermined program such as an application program stored in the flash memory 253 being a storage medium to the RAM 255 and performs various types of operations. The CPU 254 according to the present embodiment achieves the function of a controller 201, a measuring portion 202, and an information providing portion 203 that are shown in FIG. 1. It is to be noted that the program may be stored in a server (not shown). The CPU 24 may download the program from the server through a network and may execute the program.

As shown in FIG. 1, the listening sound obtaining apparatus 200 includes a controller 201, a measuring portion 202, and an information providing portion 203. Herein, the measuring portion 202 is a sound emitter to measure the sound pressure at any position on a transfer route of an speech sound in the voice amplification system 100. The controller 201 includes a processor, a non-volatile memory that stores a program executed by the processor, a volatile memory used as a work area by the processor, or the like. This controller 201 obtains the sound pressure at the listening position of the conference participant Mj being a listener by arithmetic operation using the sound pressure measured by the measuring portion 202. In addition, the controller 201, based on the sound pressure at the listening position, determines a relationship to an appropriate value of the sound pressure of the speech sound and provides visible information showing a determination result by the information providing portion 203.

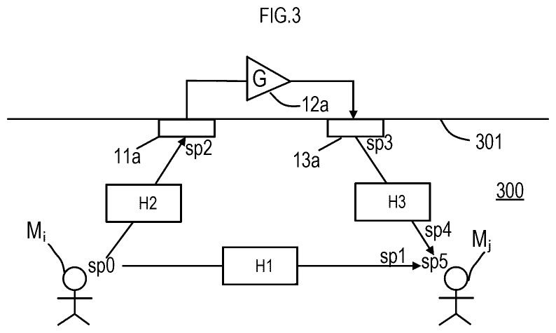

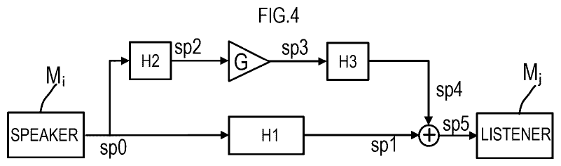

FIG. 3 is a view showing a transfer system of the speech sound in the voice amplification system 100. In addition, FIG. 4 is a block diagram that represents the same transfer system by a transfer function.

In this example, a microphone 11a as the sound collector 11, an amplifier 12a (as the amplifier 12), and a speaker 13a as the sound emitter 13 are arranged on a ceiling 301 of a conference room 300. A channel from a speech position (a position of a head, for example) of the conference participant Mi up to a listening position (a position of a head, for example) of the conference participant Mj passing through the microphone 11a, the amplifier 12a, and the speaker 13a is the voice amplification transfer route 10. In addition, a channel from the speech position of the conference participant Mi up to the listening position of the conference participant Mj without passing through the voice amplification transfer route 10 is the direct transfer route 20.

In this example, when the sound pressure of the speech sound at the speech position is represented by sp0, the transfer function from the speech position to a sound collector of the microphone 11a is represented by H2, a total gain of the microphone 11a, the amplifier 12a, and the speaker 13a is represented by G, and the transfer function from a sound emitter of the speaker 13a to the listening position is represented by H3, a sound pressure sp4 of a sound that reaches the listening position via the voice amplification transfer route 10 is expressed by the following formula.

$$sp 4 = H 2 \cdot G \cdot H 3 \cdot sp 0 \qquad ( 1 )$$

On the other hand, when the transfer function of the direct transfer route 20 is represented by H1, a sound pressure sp1 of a sound that reaches the listening position via the direct transfer route 10 is expressed by the following equation.

$$sp 1 = H 1 \cdot sp 0 \qquad ( 2 )$$

Accordingly, a sound pressure sp5 of the listening sound at the listening position is expressed by the following equation.

$$\begin{matrix}sp 5 = sp 1 + sp 4 \\ = ( H 2 \cdot G \cdot H 3 + H 1 ) \cdot sp 0\end{matrix} \qquad ( 3 )$$

Incidentally, in the transfer system shown in FIG. 3 and FIG. 4, when an input sound pressure of the microphone 11a is represented by sp2, this sound pressure sp2 is a sound pressure at a position on the transfer route of the speech sound and expressed by the following equation.

$$sp 2 = H 2 \cdot sp 0 \qquad ( 4 )$$

Herein, a sound pressure sp0 is able to be reversely calculated from the sound pressure sp2 by the following equation.

$$sp 0 = H 2 - 1 \cdot sp 2 \qquad ( 5 )$$

Then, the controller 201 of the listening sound obtaining apparatus 200 measures the sound pressure sp2 by the measuring portion 202, performs arithmetic operation of the following equation based on this measured sound pressure sp2, and calculates the sound pressure sp5 at the listening position.

$$\begin{matrix}sp 5 = ( H 2 \cdot G \cdot H 3 + H 1 ) \cdot sp 0 \\ = ( H 2 \cdot G \cdot H 3 + H 1 ) \cdot H 2 - 1 \cdot sp 2\end{matrix} \qquad ( 6 )$$

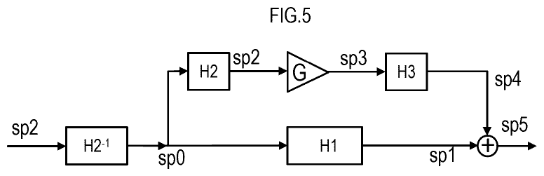

FIG. 5 represents arithmetic content of this equation (6) as a block diagram.

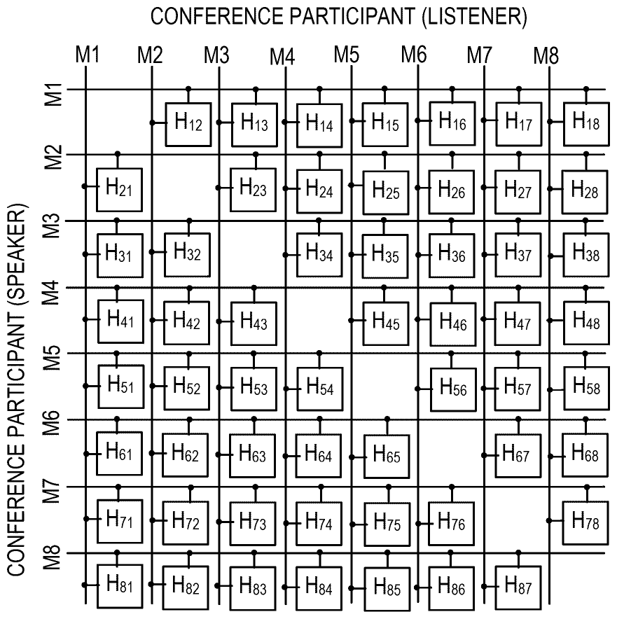

Next, the function of the listening sound obtaining apparatus 200 will be more generally described. FIG. 6 is a block diagram showing the transfer system of the speech sound of the voice amplification system 100 when the number N of conference participants is eight. In this voice amplification system 100, normally, any one among the N conference participants Mi (i=1N) is a speaker and the remaining N-1 persons are listeners. FIG. 6 shows N horizontal lines (N=8 in this example) connected to the vertically arranged conference participants Mi (i=1−N). These horizontal lines show channels in which a sound spoken by the conference participant Mi (i=1−N) propagates. In addition, FIG. 6 shows N vertical lines connected to the horizontally arranged conference participant Mj (j=1−N). These vertical lines show channels in which a sound listened to by the conference participant Mj (j=1−N) propagates. In addition, FIG. 6 shows a transfer function Hij at each intersection of each horizontal line connected to the conference participant Mi (i=1−N) and each vertical line connected to the conference participant Mj (j=1−N and j≠i). This transfer function Hij is a transfer function of a transfer route in which the voice amplification transfer route 10 and the direct transfer route 20 interposed between the conference participants Mi and Mj (j≠i) are parallelly connected. The speech sound of the conference participant Mi being a speaker reaches the conference participant Mj being a listener through the transfer function Hij.

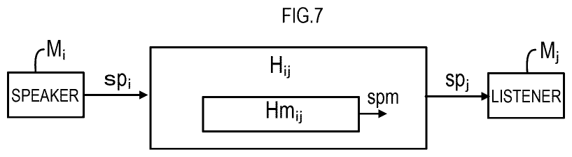

FIG. 7 shows the transfer function Hij of the transfer route interposed between the conference participants Mi and Mj (j≠i). In the present embodiment, this transfer route includes a transfer route that transmits the speech sound. Herein, a transfer function Hmij is a transfer function representing a part of the transfer function Hij and spm represents a sound pressure at any position. According to this, the listening sound obtaining apparatus 200 is able to obtain the sound pressure (spm) at any position on the transfer route of the speech sound and calculate the sound pressure at the listening position of the listener based on the obtained sound pressure. Specifically, the listening sound obtaining apparatus 200, when being able to obtain the sound pressure spm, is able to calculate a sound pressure spi by using an inverse function of the transfer function Hmij.

$$spi = Hmij - 1 \cdot spm \qquad ( 7 )$$

When spi is able to be calculated, spj is able to be calculated as in the equation (3).

$$\begin{matrix}spj = Hij \cdot spi \\ = Hij \cdot Hmij - 1 \cdot spm\end{matrix} \qquad ( 8 )$$

Then, in the present embodiment, the controller 201, based on the sound pressure spm, executes the arithmetic operation shown in the above equation (8) and calculates the sound pressure spj at the listening position (N-1 points) of the conference participant Mj (j=1−N and j≠i) being a listener.

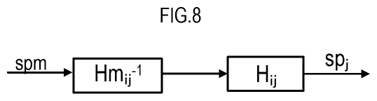

FIG. 8 represents the arithmetic operation of the equation (8) by a block diagram.

The correspondence relationship between this generalized embodiment and the above embodiments in FIG. 3 and FIG. 4 is as follows, for example.

<Example 1: In a case of spm=sp2>
spm=sp2
Hmij=H2
spi=sp0
spj=sp5
Hij=H2·G·H3+H1
<Example 2: In a case of spm=sp4>
spm=sp4
Hmij=H2·G·H3
spi=sp0
spj=sp5
Hij=H2·G·H3+H1

As described by use of the above Example 1 and Example 2, the case in which the sound pressure is obtained at the position of sp2 is defined as Hmij=H2 and the case in which the sound pressure is obtained at the position of sp4 is defined as Hmij=H2·G·H3. As described above, it is necessary to use an inverse function Hmij-1 corresponding to the position at which the sound pressure is obtained. In the present embodiment, in order to obtain the sound pressure at the listening position, it is necessary to use the transfer function Hij of the transfer route interposed between the conference participants Mi and Mj (j≠i) and the transfer function Hmij of the transfer route that generates a monitor sound. In the present embodiment, at a time of installing of the voice amplification system 100, the position of the head of the conference participant Mi (i=1−N) is determined and the characteristics of each part of the voice amplification transfer route 10 are optimized, based on the position. According to this, the content of the transfer functions Hij and Hmij is also determined. Then, in the present embodiment, at the time of installing of the voice amplification system 100, the transfer functions Hij and Hmij are generated by arithmetic operation, simulation, or the like and stored in a non-volatile memory of the controller 201. Then, at a time of operation of the voice amplification system 100, the controller 201 obtains the sound pressure at the listening position by using the stored transfer functions Hij and Hmij.

In addition, in the present embodiment, in order to obtain the sound pressure at the listening position, it is necessary to use the transfer functions Hij and Hmij associated with the conference participant Mi being a speaker. Therefore, it is necessary to specify the conference participant Mi being an speaker. Although various kinds of sound emitters are able to be considered with respect to detection of an speaker, for example, in a case in which the microphone 11a placed in the conference room 300 is a microphone that is able to control directivity so as to collect the speech sound with a high gain, an speaker may be detected by use of this microphone. In addition, in a case in which speaker detection by the microphone 11a is difficult, the conference participant Mi (i=1−N) in the conference room 300 is captured with a camera, for example, and a conference participant who is performing a speech may be detected by executing recognition processing on a captured image.

The controller 201, when obtaining the sound pressure at the listening position of N-1 points, based on the obtained sound pressure, determines a relationship to an appropriate value of the sound pressure of the speech sound and provides visible information showing a determination result by the information providing portion 203.

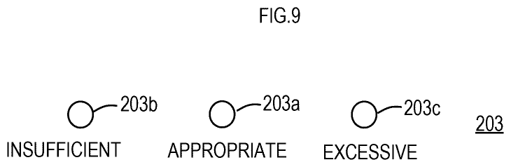

FIG. 9 is a view showing an example of the information providing portion 203. This information providing portion 203 has an appropriate lamp 203a attached with the characters of “appropriate,” an insufficient lamp 203b attached with the characters of “insufficient,” and an excessive lamp 203c attached with the characters of “excessive.” In a preferable aspect, these appropriate lamp 203a, insufficient lamp 203b, and excessive lamp 203c are turned on in different luminous colors. The information providing portion 203, for example, is placed near the sound emitter. The position in which the information providing portion 203 is placed may be any position as long as an speaker can easily check. For example, the position in which the information providing portion 203 is placed, in a scene in which an speaker speaks, may also be an easily visually recognizable position. Specifically, when the information providing portion is placed at the position of a speaker, the speaker can check that speech is performed at an appropriate sound pressure by looking at the speaker actually emitting a sound. In addition, when the information providing portion is placed at the position near the hand of a speaker, the speaker can check that the speech is performed at the appropriate sound pressure by checking the position near the hand. For example, the position in which the information providing portion 203 is placed may be a position at which an installer can be easily checked at the time of installing the voice amplification system. Specifically, when the information providing portion is configured to be provided on a screen of a computer that the installer uses, the installer can easily check that the speech is performed at the appropriate sound pressure by checking the own computer during installation work.

The controller 201, in a case in which all the sound pressures at listening positions of the N-1 points are within an appropriate range, turns on the appropriate lamp 203a. In addition, the controller 201, in a case in which the sound pressure in at least one point at the listening positions of the N-1 points is below the minimum of the appropriate range, turns on the insufficient lamp 203b. In this case, the speaker increases a speech sound pressure. In addition, the controller 201, in a case in which the sound pressure in at least one point at the listening positions of the N-1 points is above the maximum of the appropriate range, turns on the excessive lamp 203c. In this case, the speaker reduces the speech sound pressure.

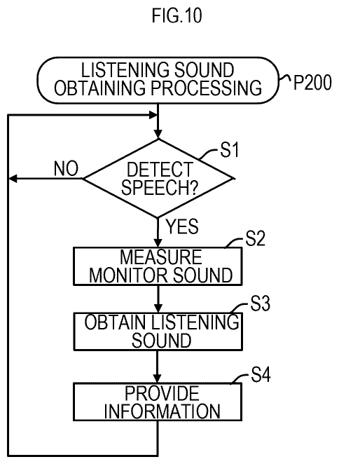

Next, an operation of the present embodiment will be described. In the present embodiment, a processor of the controller 201 repeatedly executes listening sound obtaining processing P200 shown in FIG. 10 according to the program in the non-volatile memory.

First, the processor of the controller 201 determines whether or not the speech is detected (Step S1). This determination is, for example, executed based on a sound collecting state (specifically, whether or not the speech sound is being collected or which speech sound of the conference participant is being collected) or the like of the sound collector 11. In a case in which the determination result of Step S1 is “NO,” the processor of the controller 201 repeats the determination of the step S1.

In a case in which the determination result of Step S1 is “YES,” the processor of the controller 201 measures the sound pressure spm of the monitor sound at the position on the transfer route of the speech sound of the conference participant being an speaker by the measuring portion 202 (Step S2).

Next, the processor of the controller 201 calculates a sound pressure SPj (j=1−N and j≠i) at the listening positions of the N-1 points, by using the transfer functions Hij and Hmij-1 associated with the conference participant Mi being an speaker and the sound pressure spm of the monitor sound obtained in Step S2 (Step S3).

Next, the processor of the controller 201, based on the sound pressure SPj (j=1−N and j≠i) at each listening position calculated in Step S3, determines a relationship to the appropriate value of the sound pressure of the speech sound and provides the speaker by the information providing portion 203 with the visible information showing the determination result (Step S4). After this step S4 is completed, the processing returns to Step S1.

In the present embodiment, the processing of Steps S1-S4 is repeated as described above. Then, when an speech occurs, the sound pressure at each listening position is calculated, the relationship to the appropriate value of the sound pressure of the speech sound is determined, based on the calculation result, and the determination result is shown to the speaker. Accordingly, the speaker can change the speech sound pressure so that the speech sound pressure may reach each listener at the appropriate sound pressure.

### Other Embodiments

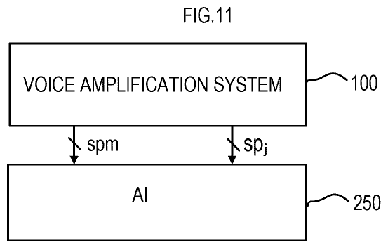

As described above, although one embodiment of the present invention is described, other embodiments may be considered as the present invention. Examples are as follows.
(1) In the above embodiment, the listening sound obtaining apparatus 200 measures the sound pressure (sp2 in FIG. 3) of the input sound of the sound collector 11 and calculates the sound pressure at the listening position by the arithmetic operation based on this measured sound pressure. However, the listening sound obtaining apparatus 200 may calculate the sound pressure at the listening position based on the sound pressure other than the sound pressure of the input sound of such a sound collector 11. For example, the listening sound obtaining apparatus 200 may measure the sound pressure (sp3 in FIG. 3) of the output sound of the sound emitter 13 and may calculate the sound pressure at the listening position by the arithmetic operation based on this measured sound pressure. Alternatively, the listening sound obtaining apparatus 200 may measure the sound pressure (sp2 in FIG. 3) of the input sound of the sound collector 11 and the sound pressure (sp3 in FIG. 3) of the output sound of the sound emitter 13 and may calculate the sound pressure at the listening position by the arithmetic operation based on this measured sound pressure. Alternatively, the listening sound obtaining apparatus 200 may measure the sound pressure (sp0 in FIG. 3) of the speech sound at the speech position and may calculate the sound pressure at the listening position by the arithmetic operation based on this measured sound pressure.
(2) In the above embodiment, the listening sound obtaining apparatus 200, although obtaining the sound pressure at the listening position by using the previously determined transfer functions Hij and Hmij-1, may calculate head positions (in other words, the speech position and the listening position) of the conference participant Mi (i=1-N), for example, by an image captured with a camera, distance measurement by LiDAR (Light Detection and Ranging), or the like and may generate a transfer function of the transfer route interposed between each conference participant, based on these head positions. In addition, the listening sound obtaining apparatus 200 may measure environmental information such as a position of a wall surface of the room or quality (reflectivity) of a material of the wall surface, by the image captured with a camera, the distance measurement by LiDAR, or the like and may generate a transfer function of the transfer route interposed between each conference participant based on the environmental information. More specifically, the listening sound obtaining apparatus 200 calculates the position of the wall surface of the room, the quality (the reflectivity) of the material of the wall surface of the room, a distance between a speaker and the sound collector 11, a distance between the sound emitter 13 and a listener, and a distance between the speaker and the listener. The listening sound obtaining apparatus 200 calculates the transfer function H1 from the speech position to the listening position based on the distance between the speaker and the listener, a positional relationship between the speaker and the wall surface, a positional relationship between the listener and the wall surface, and the reflectivity of the wall surface. The listening sound obtaining apparatus 200 calculates the transfer function H2 from the speech position to the sound collector of the microphone 11a based on the distance between the speaker and the sound collector 11, the positional relationship between the speaker and the wall surface, a positional relationship between the sound collector 11 and the wall surface, and the reflectivity of the wall surface. The listening sound obtaining apparatus 200 calculates the transfer function H2 from the speech position to the sound collector 11 based on the distance between the speaker and the sound collector 11, the positional relationship between the speaker and the wall surface, and the reflectivity of the wall surface.
(3) In the above embodiment, the listening sound obtaining apparatus 200, although calculating the sound pressure at the listening position by the arithmetic operation, may make a determination by selecting an appropriate sound pressure from database (matrix or the like) measured in advance. Each of the microphone and the speaker may include a plurality of microphones and speakers as long as the matrix is appropriately set.
(4) As illustrated in FIG. 11, the listening sound obtaining apparatus 200 may achieve an AI (artificial intelligence) 250. In the aspect shown in FIG. 11, in the voice amplification system 100, each conference participant Mi (i=1−N) is caused to perform speech. The sound pressure spm of the monitor sound to be obtained from the voice amplification system 100 at that time and the sound pressure spj at the listening position are given to the AI 250 as teaching data, and the AI 250 is caused to learn the relationship between the sound pressure spm of the monitor sound and the sound pressure spj at the listening position. Then, at the time of full operation of the voice amplification system 100, the AI 250 calculates the sound pressure spj at the listening position based on the sound pressure spm of the monitor sound to be obtained from the voice amplification system 100.
(5) The information providing portion 203 may place an object corresponding to each of the conference participants Mi (i=1−N), for example, in front of each conference participant. In this aspect, in a case in which a certain conference participant Mi is an speaker, the information providing portion 203 corresponding to the conference participant Mi provides visible information showing the relationship to the appropriate value of the speech sound pressure.
(6) In a case in which the sound emitter 13 includes a plurality of sound emitter, the listening sound obtaining apparatus 200 may place the information providing portion 203 in association with each sound emitter 13.
(7) In the above embodiment, the listening sound obtaining apparatus 200, although determining the relationship to the appropriate value of the speech sound pressure, based on the sound pressure at the listening position, may determine the relationship, based on a sound pressure other than the sound pressure at the listening position.
(8) In the above embodiment, the listening sound obtaining apparatus 200, although dividing and displaying the relationship to the appropriate value of the speech sound pressure into three ranks: insufficient, appropriate, and excessive, may divide and display the relationship into four or more ranks. Alternatively, the listening sound obtaining apparatus 200 may display for each listening position a bar graph (display as a continuous value) of the speech sound pressure calculated from the sound pressure at the listening position.
(9) With respect to the voice amplification transfer route 10, a gain may be set in advance such that basic human speech volume may be in a reasonably appropriate amplification degree. According to this, the speech sound pressure to cause an amplification state to be appropriate is able to be set within a reasonable range for a speaker.
(10) The listening sound obtaining apparatus 200, in the transfer system shown in FIG. 3, in a case in which the sound pressure sp1 of the sound that reaches the listening position via the direct transfer route 10 satisfies a certain condition (a first condition), may regards the sound pressure sp4 of the speech sound that reaches a listener through the voice amplification transfer route 10 as a sound pressure sp5 at a position of the listener. For example, the listening sound obtaining apparatus 200, in a case in which the sound pressure sp1 is sufficiently small, determines that the first condition is satisfied and also set the sound pressure sp4=the sound pressure sp5. The listening sound obtaining apparatus 200, in a case in which the distance between the conference participant Mi and the conference participant Mj exceeds a predetermined threshold value, for example, may determine that the first condition is satisfied, may disregard the sound pressure sp1, and also set the sound pressure sp4=the sound pressure sp5. In addition, the listening sound obtaining apparatus 200, in a case in which the gain of the voice amplification transfer route 10 is high and a value of the sound pressure sp4 is higher than the sound pressure sp1 by a predetermined value or more, may determine that the first condition is satisfied and also set the sound pressure sp4=sp5. Alternatively, the listening sound obtaining apparatus 200, in a case in which an acoustic obstacle such as a wall, a partition, or the like is present between the position of a speaker and the position of a listener, may determine that the first condition is satisfied and also set the sound pressure sp4=sp5. Alternatively, the listening sound obtaining apparatus 200, in a case of receiving a setting without using the sound pressure sp1 of a speaker from a user, may determine that the first condition is satisfied and also set the sound pressure sp4=sp5.

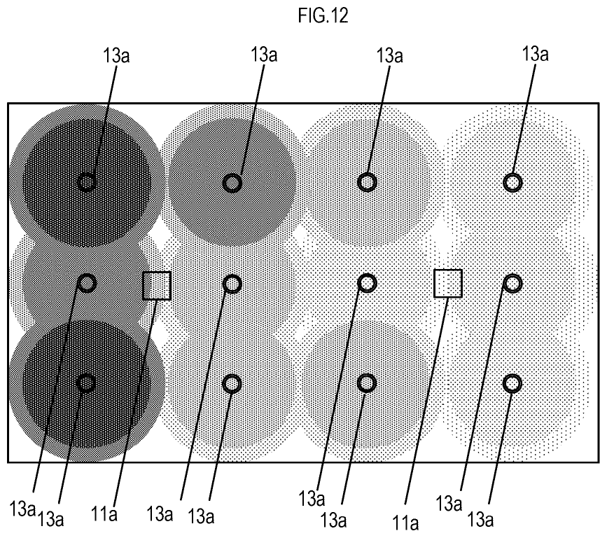

The listening sound obtaining apparatus 200, in a case in which the sound pressure sp1 of the sound that reaches the listening position via the direct transfer route 10 does not satisfy the first condition (in a case in which the sound pressure sp1 is sufficiently large, in a case in which the distance between the conference participant Mi and the conference participant Mj is below a predetermined threshold value, in a case in which the value of the sound pressure sp4 in comparison with the sound pressure sp1 is less than a predetermined value, in a case in which the acoustic obstacle such as a wall, a partition, or the like is absent between the position of an speaker and the position of a listener, in a case in which a user does a setting that uses the sound pressure sp1), calculates the sound pressure sp5 at the position of the listener as sp1+sp4 based on the obtained sound pressure sp4 and the sound pressure sp1 of the speech sound.
(11) FIG. 12 is a diagram showing a modification of visible information. In this example, the listening sound obtaining apparatus 200 provides a speaker with a sound pressure at a listening position as sound pressure distribution, in a display 251. The example of FIG. 12 shows the microphone 11a and the speaker 13a on a schematic diagram in a plan view of a conference room. In addition, in the example of FIG. 12, the listening sound obtaining apparatus 200 displays the sound pressure in respect of listening by color density. For example, a dark-colored part has a high sound pressure and a light-colored part has a low sound pressure. The listening sound obtaining apparatus 200 may display the sound pressure in respect of listening by difference in color. The listening sound obtaining apparatus 200, for example, may display the color of a position with high sound pressure in red and the color of a position with the low sound pressure in blue.

Although the example of FIG. 12 shows two microphones 11a, the listening sound obtaining apparatus 200 may display a screen that is different between a first microphone 11a and a second microphone 11a and may display the sound pressure distribution for each microphone. In addition, the listening sound obtaining apparatus 200 may change the color of the sound pressure for each microphone. For example, the listening sound obtaining apparatus 200 may display the sound pressure distribution by density of red in the first microphone 11a and may display the sound pressure distribution by density of blue in the second microphone 11a. It is to be noted that, in a case in which the number of microphones is further large (in a case of four, for example), the listening sound obtaining apparatus 200 may assign each of red, blue, green, and light blue, for example, and may represent information including an appropriate value, sound pressure, or the like by each contrasting density. According to this, whether each volume of plurality of talkers is able to be appropriately amplified in a venue can be intuitively grasped. In addition, the listening sound obtaining apparatus 200 may receive a selection of a specific microphone from a user and may display only the selected specific microphone. The listening sound obtaining apparatus 200, for example, in a case in which four microphones are present, for example, in a case of receiving a selection of the first microphone, displays information showing whether a sound collected by the first microphone is appropriately amplified. Alternatively, the number of selected microphones is not limited to one but may be two, three, or more than the above. In addition, the listening sound obtaining apparatus 200 may automatically select a microphone that receives an input of the largest sound pressure.

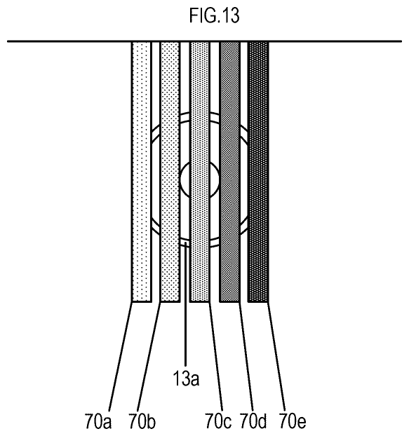

According to this, the speaker can intuitively grasp the speech sound pressure that reaches the inside of the conference room at a glance and can easily change the speech sound pressure so as to send a voice to a listener at the appropriate sound pressure.
(12) The visible information may be a display such as an LED or the like provided for each speaker. The listening sound obtaining apparatus 200, for example, may light the LED in blue when the sound pressure is insufficient. In addition, the listening sound obtaining apparatus 200 may light the LED in red when the sound pressure is excessive. The listening sound obtaining apparatus 200 may light the LED in green when the sound pressure is adequate. In addition, the listening sound obtaining apparatus 200 may change the brightness of the LED according to the sound pressure. The listening sound obtaining apparatus 200, for example, may darken the LED when the sound pressure is insufficient and may brighten the LED when the sound pressure is excessive.
(13) The listening sound obtaining apparatus 200 may guide a determination result with sensory information by a voice. For example, the listening sound obtaining apparatus 200 may guide with the voice of “please turn up the voice” when the sound pressure is insufficient and may guide with the voice of “please turn down the voice” when the sound pressure is excessive.
(14) The listening sound obtaining apparatus 200 may guide the determination result with the sensory information by vibration. In this case, the listening sound obtaining apparatus 200 includes a vibration device that the speaker carries. The listening sound obtaining apparatus 200 vibrates the vibration device when the sound pressure is insufficient and when the sound pressure is excessive.
(15) FIG. 13 is a diagram showing a modification of the visible information. In this example, the listening sound obtaining apparatus 200 provides a speaker with the visible information showing the relationship to the sound pressure of a speech sound by placing at a plurality of points an index that changes corresponding to (proportional to, for example) the magnitude of the sound pressure. More specifically, in this example, a plurality of ribbons 70a-70e are placed in front of the speaker 13a as the index. The plurality of ribbons 70a-70e hang down from, for example, the ceiling of the conference room. The plurality of ribbons 70a-70e each have a different color and physical property. The physical property includes an elastic modulus (hardness) or weight, for example. The ribbon 70a has the lightest color and is the softest (or light). The ribbon 70e has the darkest color and is the hardest (or heavy). Accordingly, the ribbon 70a is the easiest to move. The ribbon 70a moves even when the sound pressure of the speaker 13a is low. The ribbon 70e is the hardest to move. The ribbon 70e moves in a case in which the sound pressure of the speaker 13a is high. In short, the ribbons 70a-70e sequentially move as the sound pressure of the speaker 13a is increased. According to this, the speaker can visually recognize the sound pressure by looking at the movement of the ribbons 70a-70e. For example, the speaker can determine that the sound pressure is excessive when the ribbon 70e moves. In addition, the speaker can determine that the sound pressure is insufficient when only the ribbon 70a moves.

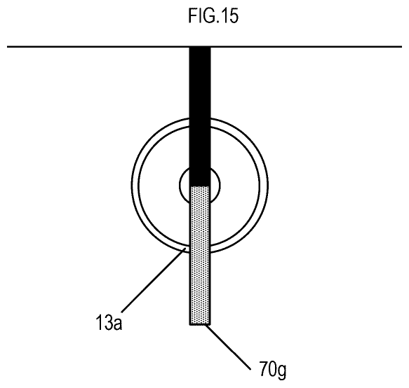

FIG. 15 is a diagram showing a further modification of the visible information. In the example of FIG. 15, a ribbon 70g of which only the part moves with respect to the sound pressure (70 dB or more, for example) equal to or larger than a predetermined value is placed in front of the speaker 13a. A part on a lower side of the ribbon 70g is a member having a low elastic modulus or light weight. A part on an upper side from a predetermined position of the ribbon 70g is a member having a high elastic modulus or heavy weight. In a case in which the sound pressure reaches an appropriate value, only the part on the lower side of the ribbon 70g moves. According to this, the speaker can visually recognize that the sound pressure has reached the appropriate value by looking at the movement of the ribbon 70g .

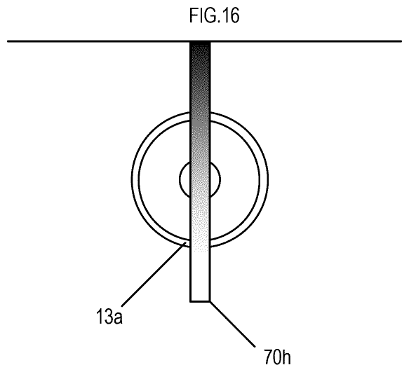

FIG. 16 is a diagram showing a further modification of the visible information. A ribbon 70h shown in the example of FIG. 16 has a high elastic modulus (or has a heavy weight) as being at a position near the ceiling, and a low elastic modulus (or has a light weight) as being at a position away from the ceiling. In short, the ribbon 70h moves the lower side when the sound pressure of the speaker 13a is low, and also moves the upper side as the sound pressure is high. In this case as well, the speaker can also visually recognize the sound pressure by looking at the movement of the ribbon 70h. For example, the speaker can determine that the sound pressure is excessive when the entire ribbon 70h moves. In addition, the speaker can determine that the sound pressure is insufficient when only the part on the lower side of the ribbon 70h moves.

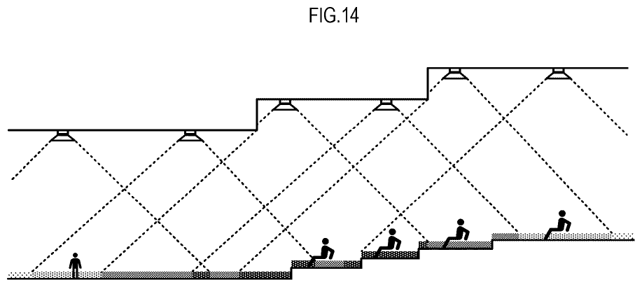

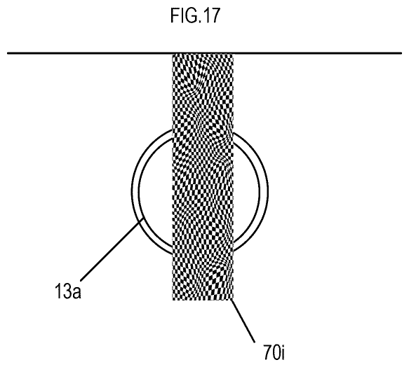

FIG. 17 is a diagram showing a further modification of the visible information. A ribbon 70i shown in the example of FIG. 17 is thin film-like and is a member having a low elastic modulus and light weight as a whole. Accordingly, the entirety of the ribbon 70i vibrates even with a low sound pressure. In addition, the ribbon 70i has a main surface on which a patterned design is formed. When the ribbon 70i vibrates, the patterned design swings. The speaker can visually recognize the magnitude of the sound pressure by looking at the swing of the patterned design of the ribbon 70i. For example, the speaker can determine that the sound pressure is excessive in a case in which the design of the ribbon 70i intensely swings. In addition, the speaker can determine that the sound pressure is insufficient in a case in which the swing of the design of the ribbon 70i is small.
(16) The listening sound obtaining apparatus 200 may calculate the sound pressure at any position on the transfer route, from the level of an audio signal to be supplied to the speaker. Alternatively, the listening sound obtaining apparatus 200 may calculate the sound pressure at any position on the transfer route, from a driving voltage of the speaker.
(17) The visible information may show a ratio of a part that has the appropriate sound pressure to the entire room. The listening sound obtaining apparatus 200 may indicate aptitude by using a display such as an LED, an LCD, an OLED, or the like in a case in which the ratio of the part that has the appropriate sound pressure to the entire room, for example, is a predetermined value (70%, for example).
(18) “Aptitude” is not limited to a case in which the sound pressure is aptitude. “Aptitude” may be whether or not frequency characteristics are appropriate. “Aptitude” may be whether or not the sound pressure of a speech voice to the sound pressure of noise is aptitude. In addition, “aptitude” may be a determination result based on an index (STI: Speech Transfer Index) by which articulation of the voice is evaluated. The voice is hardly heard when the original waveform deforms due to reverberation, noise, or the like, in process of transfer. The STI is an index by which the articulation of the voice is evaluated, depending on how accurately the voice is transmitted without such waveform deformation. In the present embodiment, by the simulation, the measurement, or the like, the transfer function H1 from the speaker to the listener, the transfer function H2 from the speaker to the microphone 11a, the total gain G of the microphone 11a, the amplifier 12a, and the speaker 13a, and the transfer function H3 from the speaker 13a to the listening position are calculated. As described above, a transfer function including an amplification system is expressed by H1+(H2+H3)×G. The transfer function is able to be represented by an impulse response IR of a time domain. The listening sound obtaining apparatus 200 measures noise N such as air-conditioning noise, in advance or in a time zone without a speech. The sound pressure sp5 at the listening position is calculated by the above equation (3) or equation (6). Accordingly, the SN ratio of the speech voice and the noise is calculated by sp5/N. The STI is calculated based on IEC 60268-16, from the impulse response IR and the SN ratio. The listening sound obtaining apparatus 200 may perform display corresponding to the calculated STI in place of the sound pressure. The STI is determined based on such reference that 0.75 or above is Excellent, 0.6-0.75 is Good, or the like, for example. Accordingly, the listening sound obtaining apparatus 200 may display the numerical value of the STI or may perform the display of Excellent, Good, or the like corresponding to this reference.
(19) FIG. 14 is a side surface schematic diagram of the conference room. The listening sound obtaining apparatus 200 in this example emits light corresponding to a directivity angle of a sound to be emitted by the sound emitter and provides the speaker with a sound emission area of the sound as the visible information, by the light.

In the example of FIG. 14, a light emitter that emits the light corresponding to the directivity angle of the sound is provided in each of the speakers installed on the ceiling. A place in which the sound of a plurality of speakers reaches brightens, since illuminated by the light of a plurality of light emitters. In addition, in a case in which the ceiling has a level difference or in a case in which a partition is in a space, the light of the light emitter is blocked.

The light and the sound have a difference in diffraction conditions or attenuation rates, so that a range in which the light and the sound easily reach and a range in which the light and the sound hardly reach cannot be said to be completely the same. However, as a general tendency, a position at which the light easily reaches is able to be interpreted as a position in which the sound also easily reaches. Accordingly, the speaker can visually and intuitively understand that an amplified sound reaches a bright place and a sound hardly reaches a dark place.

What is claimed is:

1. A listening sound obtaining method for a voice amplification system, including a sound collector, an amplifier, and a sound emitter, that sends a speech sound of a speaker to a listener through at least a voice amplification transfer route that includes the sound collector, the amplifier, and the sound emitter, the listening sound obtaining method comprising:
obtaining a first sound pressure at any position on the voice amplification transfer route of the speech sound; and
calculating a second sound pressure at a listening position of the listener based on the obtained first sound pressure.

2. The listening sound obtaining method according to claim 1, further comprising:
obtaining a third sound pressure through a direct transfer route other than the voice amplification transfer route,
wherein, in a state where the third sound pressure satisfies a first condition, calculating the sound pressure at the listening position of the listener is determined to be a sound pressure of the speech sound that reaches the listener through the voice amplification transfer route as the sound pressure at a position of the listener.

3. The listening sound obtaining method according to claim 1, wherein:
the obtaining of the first sound pressure measures, using the sound collector, the first sound pressure at the any position on the transfer route of the speech sound, and
the calculating of the second sound pressure at the listening position of the listener is calculated by arithmetic operation based on the obtained first sound pressure.

4. The listening sound obtaining method according to claim 1, comprising:
measuring a sound pressure of an input sound of the sound collector; and
calculating the sound pressure at the listening position by arithmetic operation based on this measured sound pressure.

5. The listening sound obtaining method according to claim 1, wherein:
the obtaining of the first sound pressure measures a sound pressure of output sound of the sound emitter using the sound collector, and
the calculating of the second sound pressure at the listening position is calculated by arithmetic operation based on the obtained first sound pressure.

6. The listening sound obtaining method according to claim 1, wherein:
the obtaining of the first sound pressure measures a sound pressure of an input sound of the sound collector and a sound pressure of an output sound of the sound emitter using a sound collector, and
the calculating of the second sound pressure at the listening position is calculated by arithmetic operation based on the obtained first sound pressure.

7. The listening sound obtaining method according to claim 1, comprising:
measuring the sound pressure of the speech sound; and
calculating the sound pressure at the listening position by arithmetic operation based on this measured sound pressure.

8. The listening sound obtaining method according to claim 1, further comprising:
determining a relationship to an appropriate value of the calculated second sound pressure; and
providing the speaker with visible information showing the determined relationship.

9. The listening sound obtaining method according to claim 1, further comprising:
determining a relationship to an appropriate value of the calculated second sound pressure; and
providing the speaker with sensory information showing the determined relationship.

10. The listening sound obtaining method according to claim 8, comprising determining the relationship to the appropriate value of the sound pressure of the speech sound, based on the sound pressure at the listening position.

11. The listening sound obtaining method according to claim 6, further comprising placing an apparatus that provides the visible information in association with the sound emitter.

12. The listening sound obtaining method according to claim 1, further comprising providing the speaker with the calculated second sound pressure at the listening position as a sound pressure distribution.

13. The listening sound obtaining method according to claim 1, further comprising:
emitting light corresponding to a directivity angle of a sound to be emitted by the sound emitter; and
providing the speaker with a sound emission area of the sound as visible information with the emitted light.

14. The listening sound obtaining method according to claim 1, further comprising placing an index that changes corresponding to a magnitude of a plurality of sound pressures in a plurality of points to provide the speaker with visible information showing a relationship to an appropriate value of the calculated second sound pressure.

15. The listening sound obtaining method according to claim 2, further comprising:
detecting a position of a head of the speaker and a head of the listener; and
obtaining, based on the positions of the heads, a transfer function from the speaker leading up to the position of the listener through the direct transfer route, a transfer function from the speaker leading up to the sound collector, and a transfer function from the sound emitter leading up to the position of the listener,
wherein the second sound pressure at the listening position of the listener is calculated based on the obtained transfer functions.

16. A listening sound obtaining apparatus that obtains, in a voice amplification system, including a sound collector, an amplifier, and a sound emitter, that sends an speech sound of an speaker to a listener through at least a voice amplification transfer route that includes the sound collector, the amplifier, and the sound emitter, a sound pressure at a listening position of the listener, the listening sound obtaining apparatus comprising:
a controller that:
obtains a first sound pressure at any position on the voice amplification transfer route of the speech sound; and
calculates a second sound pressure at a listening position of the listener based on the obtained first sound pressure.
